(19) United States
(12) Patent Application Publication
(10) Pub. No.: US 2016/0210354 A1
(43) Pub. Date: Jul. 21, 2016

(54) METHODS FOR SEMANTIC TEXT ANALYSIS

(71) Applicant: CONTINUUM CONSULTING NV, Diepenbeek (BE)

(72) Inventors: Jeroen WIJNEN, Zonhoven (BE); Hubert MERTENS, Wiekevorst (BE)

(73) Assignee: Continuum Consulting NV, Diepenbeek, (BE)

(21) Appl. No.: 14/914,518

(22) PCT Filed: Aug. 26, 2014
(86) PCT No.: PCT/EP2014/068089

§ 371 Date: Feb. 25, 2016

(30) Foreign Application Priority Data
Aug. 26, 2013 (BE) 2013/0552
Apr. 4, 2014 (BE) 2014/0231

(51) Int. Cl. G06F 17/30

(52) U.S. Cl. CPC G06F 17/30684

(57) ABSTRACT

The invention provides (computer implemented) methods for such text analysis (text search, text mining), related systems, software, graphical user interfaces and use thereof. The invention provides methods and systems taking into account the operational context for which said methods and systems are deployed.

### FIELD OF THE INVENTION

The invention relates to (computer implemented) methods for text analysis (like text search and/or text mining), related systems, software, graphical user interfaces and use thereof.

### BACKGROUND OF THE INVENTION

While the concept of use of (computer implemented) methods for text analysis (like text search and/or text mining) and notably the use of semantic relationship therein exist, especially from academic research, practical industrial application thereof remains hampered by achieved speed for delivering the results while retaining a sufficiently high quality.

While in essence state of the art methods try to a find the ‘best’ solution and stick to a fixed format within this context or go at most to the level of combining state of the art methods, leading to computational intensive or inadequate methods.

### AIM OF THE INVENTION

It is the aim of the invention to provide (computer implemented) methods for such text analysis, related systems, software, graphical user interfaces and use thereof, which overcome this technical problem, by deviating or going beyond from the known academic research solutions to thereby achieve the required speed while still be able to provide a from practical viewpoint surprisingly good quality.

### SUMMARY OF THE INVENTION

In a first aspect of the invention a (computer implemented) method (which when executed on a processing engine, like one or more computer systems) performs (automated or semi-automated) analysing a plurality of second texts to either find themes in said second texts (text mining) and/or identifying for a first text one or more texts in said plurality of second texts resembling said first text (text search). In this first aspect of the invention one goes beyond the one size fits all approach or mere combinations thereof as found in the state-of-the art by providing at least the steps of: (1) loading said plurality of second texts, each of said (second) texts being provided in a first format, wherein said first format may provide first semantic relationships between said texts; (2) determining characteristics of said plurality of second texts to thereby define an operational context (business case); (3) performing said analysis of said plurality of second texts by using one of a plurality of different methods, the used method being (automatically) selected in accordance with and only by use of said operational context in order to obtain a predefined performance goal, in particular in terms of execution time.

In an embodiment of said first aspect of the invention said analysis is to at least identify for a first text one or more texts in said plurality of second texts resembling said first text, said method further comprising: (4) inputting characteristics of to be entered first texts, to thereby further define said operational context (business case); (5) entering said first text; (6) determining at least one first reference text in said plurality of second texts, resembling to a certain extent said first text; (7) determining within said plurality of second texts one or more texts resembling said first text, said determining starting with said first reference text and wherein for step (6) and/or (7) use of one of a plurality of different methods is (automatically) selected in accordance said operational context in order to obtain a predefined performance goal.

In an alternative embodiment (possibly used together with the above embodiment or wherein said above embodiment is used) said analysis is for identifying one or more themes in said plurality of second texts, possible in a first step first texts (automatically) are generated; and in subsequent steps the method for text searching is iteratively executed using such generated texts. The use of one or more different methods can (automatically) be selected in accordance with the operational context in order to obtain a predefined performance goal.

In a further embodiment of the invention (applicable to both text search and/or text mining) the use of various formats for expressing relationships between said second texts, more in particular the carefully selection on when and how to use one or another format, knowing that one format might be less computational intensive or pre-determined while the other format might be very computational intensive but quality wise more powerful, is provided. Alternatively stated the (computer implemented) method for identifying for a first text in a plurality of second texts one or more texts resembling said first text or equivalently theme searching, will involve loading said plurality of second texts, each of said (second) texts being provided in a first (pre-determined) format, wherein said first format may provide first relationships between said texts, for instance expressed in terms of relationships between groups of words found in said texts.

In a further embodiment thereof (applicable to both text search and/or text mining) step (7) comprises: (a) processing a part of said plurality of second texts in order to arrange them in a second format, wherein said second format provides second relationships between said texts, said second format expresses the semantic resemblances between said texts better than said first format (for instance said second texts become linked in accordance with their (semantic) resemblance) and (b) thereafter said determining of one or more texts is being based on second format. (c) In the same way, determining themes is based on second format.

In yet another embodiment of the invention (applicable to both text search and/or text mining) the use of the operational or business case dependent approach is combined as such (each independently) but preferably mutually strengthen each other with the various format case approach, more in particular said step of determining may comprise: (a) pre-selecting (with search or comparison with said first text) which second texts will be used in said determining step; (b) searching through said plurality of second texts; and (c) selecting (for instance based on a ranking) which second texts will be retained after step (b); and whether one or more of said steps (a)(b)(c) exploits one of various formats (e.g. either said first or second format) is (automatically) selected in accordance with said operational context.

In yet another embodiment of this aspect of the invention, whereby a (computer implemented) method (which when executed on a processing engine, like one or more computer systems) performs (automated or semi-automated) analysing a plurality of second texts to identify for a first text one or more texts in said plurality of second texts resembling said first text (case text search), the approach of “Context Revealing and Picking (CRaP)” is being used in combination with the first aspect of the invention. In this approach, starting from the first text, both (a) via first relationships the most relevant (related to the first text) texts within their most prominent context (whereby the most prominent context is being determined via second relationships) (b) and also via second relationships other related relevant contexts containing again relevant (related to the first text) texts, are returned. The combination of (a) first related texts (within their most prominent context) and (b) other second related relevant contexts (containing related texts) offers a rich, nuanced response to the said text search request.

In a second aspect of the invention a computer program product is provided (written in whatever computer program language being but not limited to Fortran, C, C++, Pascal, Java, Erlan) for executing the methods of the first aspect of the invention on a processing engine, being one or more interconnected computers being but not limited to PC's, workstations, tables, apps or combinations thereof with or without specialized means for performing certain often used functions such as parallelizing processes.

In a third aspect of the invention a non-transitory machine readable storage medium storing the computer program products of the second aspect of the invention is provided.

In a fourth aspect of the invention use of any of said methods discussed before is disclosed, wherein said entering of first texts and displaying of said determined second texts being performed at one terminal and any other part of said method steps being performed at a second different terminal, whereby said first and second terminal communicate over a wired and/or wireless (probably security protected) network.

In a fifth aspect of the invention a graphical user interface (and related computer program product or a non-transitory machine readable storage medium storing such computer program products) suited for use with any of the methods discussed before is disclosed, said graphical user interface comprises means for loading second texts; means for determining the operational or business context; means for inputting one or more first texts; means for identifying said plurality of second texts; means for displaying themes; means for displaying determined second texts; and means for inputting characteristics of said first or second texts; and optionally a means for identifying a text in said second texts as to be used as reference text by the user.

In a sixth aspect of the invention (computer implemented) methods for adding a new text into a plurality of second texts in one or more formats suitable for use in any of the methods discussed above are provided. In a first embodiment thereof such method comprise a step of determining whether the new text is a near copy of one of said second texts in accordance with a similarity criterion, preferably by use of a hash function; if said new text is (to be considered) a near copy, the new text is marked as such and not added to the plurality of second texts in said format; otherwise the new text is processed in order to add it into said plurality of second texts in said format. In a second embodiment thereof such method for creating said plurality of second texts in a format suitable for use in any of the methods, comprise the steps of: determining whether the size of the text to be added is less than a predetermined value; and if so the new text is processed in order to add it into said plurality of second text in said format; if not the new text is split into sub texts satisfying said size constraint; and each of said sub texts are processed in order to add it into said plurality of second text in said format. In a third embodiment thereof the above methods are both applied for instance sequentially on said second texts or depending on the outcome of one of said methods on a portion thereof or the creation of the database of second text might even be tuned by the operational or business context.

In a seventh aspect of the invention (computer implemented) methods also removing text from a plurality of second texts available in one or more formats suitable for use in any of the methods discussed above, is provided, in particular the consistency of those formats, preferably by taking the way texts have been added earlier into account, is addressed. More generally speaking methods for maintaining the (corpus of) second texts by adding and removing is disclosed.

In an eighth aspect of the invention a computer implemented method is proposed for identifying for a first text in a plurality of second texts a plurality of texts resembling said first text; the method comprises the steps of: (step 1) loading said plurality of second texts, each of said second texts being provided in a first format, wherein said first format provides a plurality of first semantic relationships between texts of said plurality of second texts; (step 2) getting a first text; (step 3) determining a plurality of texts resembling said first text in the plurality of second texts, wherein: at least part of said plurality of second texts is being processed to organize them in a second format, said second format defines second relationships between said texts and the first text, said second format expresses the semantic resemblance between said texts better than said first format and said determining of a plurality of texts is based on determining a plurality of contexts for the first text based on first and/or second relationships and followed by a selection of those contexts and for each of those contexts individually determining a plurality of texts based on first and/or second relationships wherein first relationships create a first context; and possibly for each of those texts within this first context second relationships create several second contexts.

In an embodiment of the invention the above method is adapted for conducting text search, more in particular by use of the approach of “Context Revealing and Picking (CRaP)” to thereby offer a rich, nuanced response to text search requests.

In an embodiment of the invention the above method is used in combination with any of the other aspects of the invention.

In a ninth aspect of the invention a computer program product for executing of the method of the eighth aspect of the invention is proposed.

In a tenth aspect of the invention a non-transitory machine readable storage medium storing the computer program products of the previous aspect of the invention is presented.

In an eleventh aspect of the invention the use of a method of the eighth aspect of the invention is presented.

In a twelfth aspect of the invention a graphical user interface (and related computer program product or a non-transitory machine readable storage medium storing such computer program products) suited for use with any of the methods discussed before is disclosed, said graphical user interface comprises means for loading second texts; means for inputting one or more first texts; means for displaying determined second texts (resembling said first text); and means for displaying contexts.

The support of the approach of “Context Revealing and Picking” by use of a graphical user interface support, further on called “angling”, comprises accompanying the returned texts with an “angling” symbol and/or button. By means of this “angling” symbol and/or button the user activates the “angling” functionality which leads to considering the related text as being the first text in the approach described by “context revealing and picking” and to returning, via the said method, (a) first related texts (within their most prominent context) and (b) other second related contexts (containing related texts). Hence, a user may start an “angling” navigation and continue it as long as the “context revealing and picking” method provides results. This leads to a rich, context-driven navigation.

The various embodiments within one aspect of the invention might be combined and the various aspects of the invention have novel and inventive contributions on their own as it is clear that the methods may benefit from data structures (such as graphs, especially carefully designed graphs especially suited for use in the invention) within or the arrangement of the supporting computer program products, while the computer program products and the flexibility introduced by the invented method provide novel and inventive contribution in the (graphical) interfacing with the user (being the actual user and/or the one configuring the methods or systems and/or the one providing the databases of data).

### BRIEF DESCRIPTION OF THE DRAWINGS

FIG. 1 shows an example of a bigram.

FIG. 2 shows the related auxiliary graph.

FIG. 3 shows an auxiliary graph obtained with the recursive procedure of the invention.

FIG. 4 demonstrates the recursive procedure.

FIG. 5 shows a generic flow chart for the invented methods.

### DETAILED DESCRIPTION

The invention provides methods and systems or engines or computer implemented kernels for text search and/or text mining (which can be pure text mining whether top-down or bottom-up or for categorization—being user assisted or automated) of (unseen) data, in particular those being based on semantic bridging, such as bridging algorithms to correlate texts (documents) semantically and/or semantic bridging patterns to conduct search and mining operations. The term unseen data refers to the fact that the engine works even though the engine has no structured information about text's content. The term semantic refers to the fact that one uses the meaning of words obtained via the context in which the words are being used. Therefor relationships (bridging) are at least based on bigrams. Those semantic relationships may play a role as well in the semantic coherence of the plurality of second texts as in one or more steps of the mining- and search-process. For those relationships one or more indicators may be used, taking into account at least the informative value (token frequency x inverse document frequency) of bigrams. One of those said indicators may be a Semantic Theme Aspect (STA). A STA is being constructed as follows: (1) based upon a threshold for the informative values of bigrams, per text of the plurality of second texts, a number of bigrams is being retained; (2) series of bigrams based upon the retained bigrams and appearing together, but not necessarily in sequence, in more texts form a STA; (3) to this STA retained bigrams appearing in only a part of the shared texts are being added; (4) smaller STA are being integrated in bigger STA. The engine is intended for both big data and normal amounts of data. Obviously the data must be translated in for computer implementation suitable data structures, enabling the underlying processing engine to recognize patterns between texts. The invention provides those methods and related aspects needed to make it actually possible to conduct search and mining operations within user acceptable performance-conditions on the one hand and user acceptable quality-conditions on the other hand. The invention further provides useful data structures (such as specially designed graphs) and computation methods (such as (bridging) formulas and related computational algorithms therefore), preferably using such data structures, to execute the methods.

Indeed, although state of the art algorithms, processes, methods and formulas might work in some theoretical context (i.e. give a reasonable quality outcome), they do not necessarily work in a real live context (e.g. big data and/or realistic performance constraints). The aim of the invention therefore is to find a balance between performance and quality that will be acceptable within the boundaries of specific business case (e.g. online search). Therefore the invented methods provide for flexibility, say having various execution modes which can be selected on the fly, say dependent on the operational context or business context. In some embodiments of the invention the one or more methods may have parameters and it is the parameter value which is selected in accordance with this operational or business context. The parameter value might for instance be stored in a look-up table, created by operating the methods for various representative business cases and by selecting (preferably under control of an optimization method) an appropriate value, most probably a set of parameters (requiring multi-dimensional optimization techniques) is determined, even more preferably techniques capable of handling multi-objective problems (here speed and quality) are used.

However the scope of the invention goes far beyond the above parametric optimization. As will be demonstrated below, entire rethinking of the methods, going beyond the one size and/or one format fits all paradigm or mere combinations thereof found in the state of the art, is provided, such rethinking leading as such to additional flexibility which can be exploited in the parametric optimization described above. More over careful analysis of the problems leading to the impracticality of state of the art solution was required and led to new use of information (business or operational context) and/or new use of a plurality of formats and/or new data structures.

The invention relates to methods and processes for storing texts (documents) in a network and/or querying and data-mining that network. Two typical user stories are (1) a user performs a free query on the network. The network returns a ranked set of to-the-query related texts (documents). The user can decide to navigate through the result set and/or (2) the network allows for a top-down, theme based zoom-in of the information in the network, whereby a theme being an aggregation of part of the second texts, preferably a content-based aggregation and preferably a human-understandable aggregation, and whereby themes are discovered in second texts also by using various methods based on the said first and/or second format. In more general terms analysis of texts (denoted in the description as second texts) stored in a format is discussed. Such information may be stored at the processing engine used by the user but also at a distant place and operated on via a wireless or wired connection. The texts are provided in an organized way, here above denoted a network. Any method of linking texts in accordance to some criteria can be applicable, preferably such organization or format, has one or more features for supporting the required analysis. Note further the engine user interaction in that the user either initiates the process by entering a query (denoted further as a first text) and/or receives the retrieved or determined second texts as a result of executing the methods. Similar user interaction is found in data mining operations.

As discussed above the information must be loaded in computer processing format and hence a step of uploading files to the network and/or underlying database (structures) is performed. After (up-) loading or inputting thereof, some processing steps can be performed.

These steps can be (a) performing non-grammatical based basic operations such as parsing, tokenizing; etc.; (b) grammatical based operations, which might vary in terms of their capability to reflect relationships between texts. One such operation is the advanced text or document bridging operation based on the theory of Semantic Theme Aspects. Besides the text data, the formats may include meta data (such as size, a time indicator, a source indicator . . . ) and even some feedback resulting from one or more previously performed analyses.

The network of texts or documents can grow (or be equivalently being reduced) over time. The invention focusses on providing methods for constructing the data bases (adding of new texts or documents or removing them), the arrangement of the data bases (more in particular providing the most suitable representations, for instance in terms of graphs) and exploiting the flexibility in grammatical based operations. Note that throughout the entire description the word text and document are both used as synonym.

In an embodiment of the invention the retrieving of information at least in part comprises the following steps of (1) finding a proxy-document or reference document (hence based upon a user-query or some mining information (typically in a top-down approach this would be themes), a proxy-document, being a document part of the underlying database, is being found. The purpose of this proxy-document is having a “hook” within the underlying network); (2) Main core extraction to move towards the most “informative” part of the network (starting from the proxy-document, and using the bridging pattern (Semantic Theme Aspects, based upon the informative value of the constructing bi-grams), the process of “main core extraction” is to move towards the most “informative” and “relevant” part of the underlying network. At this stage of the process, the “recall” parameter of the result set (of documents) should be high; (3) increasing the precision of the result set by calculating a similarity (by comparing the result set (of documents) with the proxy-document, using a similarity formula, the documents within the result set are being ranked. Using a cut-off value, the precision of the result set is increased without too much decreasing the recall parameter of the result set.

With the above based description the various aspect of the invention can be discussed in more detail. Indeed while the above procedure might be used, other procedures might be equally used, or the above indicated procedure might be used in one circumstance while not in another circumstance (depending on the business case as provided by the invention) and/or be used for some parts of the analysis only and/or a combination of the last two possibilities. Further the above procedure has some flexibility. Indeed step (1) discusses the use of a reference document but the invention also provides the use of multiple reference documents, and more in particular provides business or operational context dependent use of one or more reference documents. Further step (2) indicates that a quite sophisticated format like Semantic Theme Aspects can be used but that such format relies on a less but still informative other format like use of bi-grams. Further this step (2) indicates that the more sophisticated format must be computed or extracted (requiring processing time). Further step (2) indicates that either said sophisticated format is used only for comparing reasons and/or even used to move through the network. When recognizing those various aspects of step (2) one may introduce the necessary flexibility in the methods to achieve the required aim in that carefully a selection is made of the format to be used (and how) and extracted and on which part (location and thresholds) of the data.

In more general terms one may say that the plurality of second texts are loaded in a first format (examples are simple key-value stored data, such as but not limited to dummy-list, word/id, bigram-id/text-id, text-id/bigram-id), which may be just a parsed information set or an already more sophisticated format, expressing relationships between texts via words such as bi-grams (or N-grams). Then the method may comprise a step of (a) processing a part of said plurality of second texts in order to arrange them in a second format, wherein said second format provides second relationships between said texts, said second format expresses the semantic resemblances between said texts better than said first format (for instance said second texts become linked in accordance with their (semantic) resemblance) such as Semantic Theme Aspects and (b) thereafter said determining of one or more texts is being based on second format. Hence careful use of the computational expense second format is provided.

More over as the analysis is iteratively and progressing over the (huge) network one may on a step per step basis thereof (a) upfront selecting which second texts will be used in said determining step; (b) searching through said plurality of selected second texts; and (c) selecting which second texts will be retained after step (b); and whether one or more of said steps (a)(b)(c) exploits either said first or second format is (automatically) selected in accordance with said operational context. Or alternatively said the analysis is an iterative process wherein an intermediate set of documents is being determined being based on said (semantic) resemblance; followed by ranking said intermediate set of documents and retaining only a portion thereof; and repeating said step based on said retained documents, preferably the characteristics of said ranking and/or retaining process are being determined by said operational context.

To further explain the spirit of the invention two extreme different approaches are now discussed, namely (1) pre-calculating as much as possible upfront versus (2) pre-calculating as little as possible upfront. Both approaches will have their own business cases. Indeed, we found out that there is no “one size fits all” in reality. Obviously mixed use of those extremes, for instance each approach on a part of the data is equally possible. Obviously the binary choice here as a function of the business case can be easily extended to a choice between a plurality of possibilities as a function of the business case. More over even within each of said approaches business case specific choices can be made as will be explained further.

In the first approach to obtain quality and yet have sufficient performance, the choice is made to minimize the number of computations early in the process (as opposed to taking into account a lot of data and adding late in the process restrictive quality constraints to the formulas). This can be implemented in various ways but for instance one might decide that not all bigrams can be taken into account to calculate the Semantic Theme Aspects. So, a cut-off is needed, which is one parameter of the methods. One may select this upper cut-off value as extremely restrictive, namely in the range of 2% to 5% (so, 98% to 95% of the bigrams are neglected). Obviously the optimal value is dependent on the distribution of bigrams over the corpus (underlying database) and in an embodiment of the invention the value is automatically extracted from characteristics of the database. These findings are very surprisingly and not in line with state of the art, elaborating a cut-off value for the informative value at the other boundary, so rather high values, nor is automated selection discussed in the art. At this point, even with the above cut-off applied, the calculation of the Semantic Theme Aspects is quite computational. Therefore, we apply some special implementation techniques and, opposed to the technique explained in the state of the art, we put the bigrams in an auxiliary graph, having as nodes the actual bigrams of the network and as property for those nodes the documents they occur in and as edges the relationship that evaluates the above property and expresses “is a part of” to help us find the Semantic Theme Aspects (as roots of this graph) in a fast way. In another embodiment of this auxiliary graph, nodes and properties are switched (unique document sets become the nodes and the bigrams become the properties) in order to even more reduce the number of required calculations.

In more general terms we can state that said texts are represented in a graph format or alternatively format as key value store formats, more preferably said texts are represented in an N-gram language model, preferably a bi-gram language model. The balanced methods may decide to take into account only bi-grams having an informative value above threshold in (part) of the corpus. One could for instance only take into account bi-grams having an occurrence in at least a predetermined amount of said second texts optionally said predetermined amount is determined by said operational context. In an embodiment of the invention said second format comprising indicators (Semantic Theme Aspects) of set of words (bi-grams) shared by two or more of said second texts. Further one may use an auxiliary graph where each node represents a set of (two) consecutive words, occurring at least in two of said texts, each node having as property those set of texts wherein said set of words occurs; and the edges represent the relationship whether the set of texts indicated in the property of a first node being a subset of the property of said second node, preferably such edge only be present if the relationship cannot be represented by edges between other nodes. Alternatively another type of auxiliary graph is used where each node represents a set of bigrams (a pair of (two) consecutive words), whereby each element of the set occurs in the related set of texts of that node; and the edges represent the relationship whether the set of texts of a first node being a subset of the set of texts of said second node, preferably such edge only be present if the relationship cannot be represented by edges between other nodes.

Obviously both types of auxiliary graphs can be used either together (for instance for one part of the corpus the first type while for the other part the second type) or selectively based upon the operational context for the entire corpus.

In an alternative implementation one only uses for the majority of the calculations the skeleton of the Semantic Theme Aspects (STA). In this context, each bigram only knows its “fathers” (=parent-bigrams)—and for each up until, possibly more than one, top is reached (=root-bigrams)—and each bigram equally knows the set of related documents, but each bigram does not know its “children” (=child-bigrams). The major advantage of this implementation is its performance and maintainability: indeed, it is far more easy and much faster to only calculate the “fathers” (and related sets of documents) than to repeatedly calculate the entire STA. For the auxiliary graph this drills down to maintaining a uni-directional relationship (edges from bottom to top) instead of maintaining a bi-directional relationship (edges from bottom to top and visa verse). Determining the entire STA with all its related “children” is deferred to a late stage in the overall-process of text-mining and/or text-search (typically after filtering out non-retained documents and/or STAs) which results in limiting the expensive (in time) operations to a minimum. Different variants, whereby the switch from skeleton of STA to real STA in a different stage of the overall-process is done (and whereby before the switch one only uses the skeletons of the STAs), exist.

Surprisingly, the quality of the proxy-document (as being the best centre of information) is not that important. In fact, in the most simple implementation, whereby the document with the most words in common with the query, becomes the proxy-document, beats all other implementations tried out (as well in quality of the end result as in performance). What is important, is to use different algorithms in parallel to find (more than one) proxy in order to incorporate all business cases. In an embodiment one may combine three algorithms: (a) one suited to deal with small user-queries/mining-operations and large documents-in-the-underlying database; (b) one suited to deal with large user-queries/mining-operations and small documents-in-the-underlying database; and (c) one suited to deal with islands of information in underlying database (Hapax). When dealing with more than one proxy, we can introduce the map/reduce principle to add parallelism to the process by mapping a process per proxy-to-be-found and we determine per algorithm to reduce before or after the core extraction process. At query-time, the core extraction proofs to be the most computational part of the process. Therefore, we restrict the process to determining the main core (and not the underlying cores). Further we found out that a cut-off value to increase precision without decreasing the recall too much (after the similarity calculation) is dependent of expected recall/precision ratio rather than of distribution within database.

Put in more general terms a plurality of reference texts are determined for use as starting basis of the analysis and preferably the amount of reference texts to be used is selected in accordance with said operational context. Even more preferably one or more of the step comprises a plurality of independent threads, which are at least in part executed in parallel, more in particular when a plurality of reference texts are determined, said determining of second texts starting from any of such reference texts defines one of said threads. Moreover for execution of each of said threads thread specific (automatically determined) parameters can be used.

In the second extreme approach as little as possible is upfront pre-calculated. In such approach only the informative value of the bigrams is pre-calculated (say the first format). Semantic Theme Aspects (say the second format) are not being calculated in advance. Preferably also here cut-off values are used, which are most likely different than in the first approach. Indeed typically the cut-off value is still rather restrictive but less restrictive than in the first approach. Range between 5 to 10% seems optimal. Here the quality of the proxy document is very important and one proxy-document almost never does the trick; we need more proxy-documents. In fact, in an embodiment of the invention an elaborated following algorithm to find the necessary proxies comprises the use of different algorithms to find the proxy (CountPos, CountOneWord, SetCover . . . ) and compare the proxies amongst each other; whenever the similarity is “low” compared to the list of existing proxies retain the document as an extra proxy provided the similarity with the user-query/mining-operation is “high”. We empirically established “high” as in [0,5; 0,6] and “low” as in [0,4; 0,5]. Parallelism can introduced in the same map/reduce way as explained above. The auxiliary graph (see above) might be applied to the neighbourhood of all proxies. Again, an alternative implementation exists of (partially) working with skeletons of STAs instead of real STAs. A main core extraction is not needed. We found out that a cut-off value to increase precision without decreasing the recall too much (after the similarity calculation) is dependent of expected recall/precision ratio rather than of distribution within database.

The difference between the amounts of proxy or reference texts to be used is one parameter which is clearly business or operational context dependent. Further the selection of the method to determine those is clearly a variable parameter. Therefore the invention in more general terms described that there is a step of determining at least one first reference text in said plurality of second texts, resembling to a certain extent said first text, wherein for this step use of one of a plurality of different methods is (automatically) selected in accordance said operational context. Moreover it is mentioned that in one embodiment said reference text being the text in said plurality of second texts having most words in common with said first text. Moreover it is indicated that a plurality of reference texts might be determined for use as starting basis and even more preferably at least one of said reference texts being the text in said plurality of second texts having most words in common with said first text. Further in an embodiment the amount of reference texts to be used is selected in accordance with said operational context. The fact that one may elect not to perform the main core extraction is expressed in more general terms in that the use of a plurality of reference texts for some business cases outperforms (in quality and performance) the more expensive (in terms of computational operations) usage of second format applied to all data and the use of core extraction and therefore that one may decide to processing only a part (in the limit nothing) of said plurality of second texts in order to arrange them in a second format, wherein said second format provides second relationships between said texts, said second format expresses the semantic resemblances between said texts better than said first format (for instance said second texts become linked in accordance with their (semantic) resemblance). Further embodiments are described wherein said step of determining or analysing comprises: (a) selecting which second texts will be used in said determining step; (b) searching through said plurality of second texts; and (c) selecting which second texts will be retained after step (b); and whether one or more of said steps (a) (b) (c) exploits either said first or second format (if available) is (automatically) selected in accordance with said operational context.

Where the first approach (“Pre-calculating as much as possible upfront”) merely uses the proxy-document as a hook to get into the underlying corpus, so merely to answers the question: “Can the corpus respond in some qualitative way to the query put”. If so, give me an entrance point, the second approach really needs qualitative proxies to come up with qualitative answers. We found out that, since in the first method we “know” (i.e. we translated the entire corpus in the format we need to understand the content and the interrelations) everything what's in the corpus—navigating from the proxy via the informative bridges (the informative bridges are the Semantic Theme Aspects, the navigation is done by calculation of the main core extraction (=translating a bipartite relation between documents and Semantic Theme Aspects into a unipartite relation between documents)) brings us to the most informative part of the corpus (most informative relative to the query). In the second approach, we do not “know” the whole corpus, since we only did some basic calculations that prepare the data to be translated quicker into its final format; then, at query time, we only “look in the neighbourhood of the proxies” (i.e. we do the remaining calculations, but only for the part of the corpus in the neighbourhood of the proxies). The only way we can hope to find the most informative part of information in the corpus is by taking qualitative proxies (i.e. proxies that are themselves in the neighbourhood of that most informative part of the corpus). So, the second approach can be seen as taking “probes” in the corpus and looking for the information in the neighbourhood of those probes. The first method is really one of diving into the corpus via some entrance point and navigating until one reaches the core of information. A side effect of the different approach towards the most informative part of the corpus is that in the second approach, there is no need to navigate away from the proxy and therefore there is no need to perform the main core extraction. Further different with the state of the art, which offers thresholds to increase quality (i.e. increase precision via cut-off after similarity calculation), we added thresholds to obtain acceptable performance without losing too much of quality. The basic strategy has been one of restricting the number of calculations as much as possible upstream the process. So, we prefer restraining at early steps rather than filtering at later steps. Partially working with skeletons of STAs rather than with the real STAs is part of the same strategy.

It is the fundamental understanding of the behaviour of semantic based searches or analysis that leads to the exploiting of flexibility within the invented methods in terms of reference documents to be used (amount and type), when and for what use more sophisticated formats (say going beyond the use of the first format and electing to determine the second format) are used. So instead of starting upfront tedious calculations, determining characteristics of said plurality of second texts to thereby define an operational context (business case) and possibly inputting characteristics of to be entered first texts also and further use of such information is provided.

In an embodiment related to a text-mining context, various methods can be used, all based upon the said first and/or second format, to come up with themes of the unseen data (plurality of second texts). Indeed, one of those various methods may exploit the very content of the bridging pattern itself (i.e. of the Semantic Theme Aspects). It does so by combining the Semantic Theme Aspects—document relation in combination with other elements of the first format (such as number of related documents, total and/or average informative value . . . ). Another method (to come up with themes) would reuse one of the regular processing steps, namely the core extraction step, for a different purpose, namely to discover the themes of the plurality of second texts. The latter core extraction step—for this purpose—is modified to not only return the highest core but also cores below that highest core.

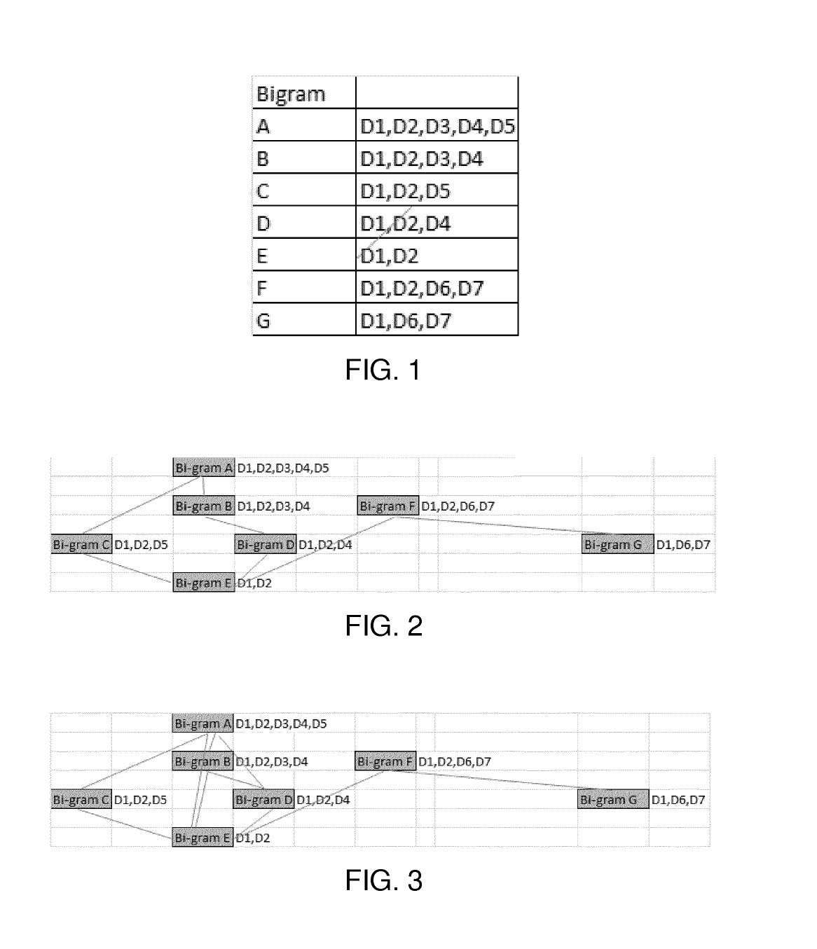

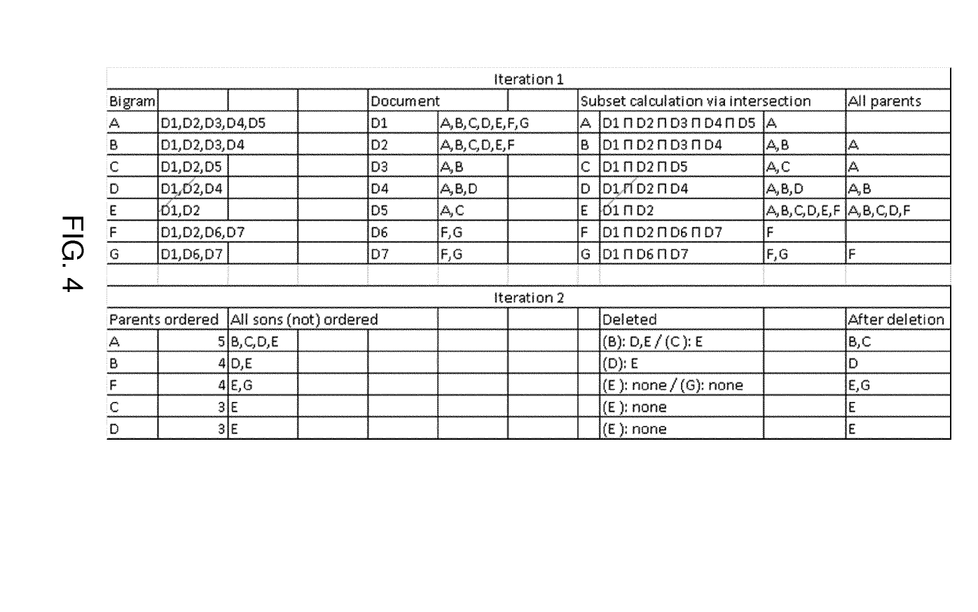

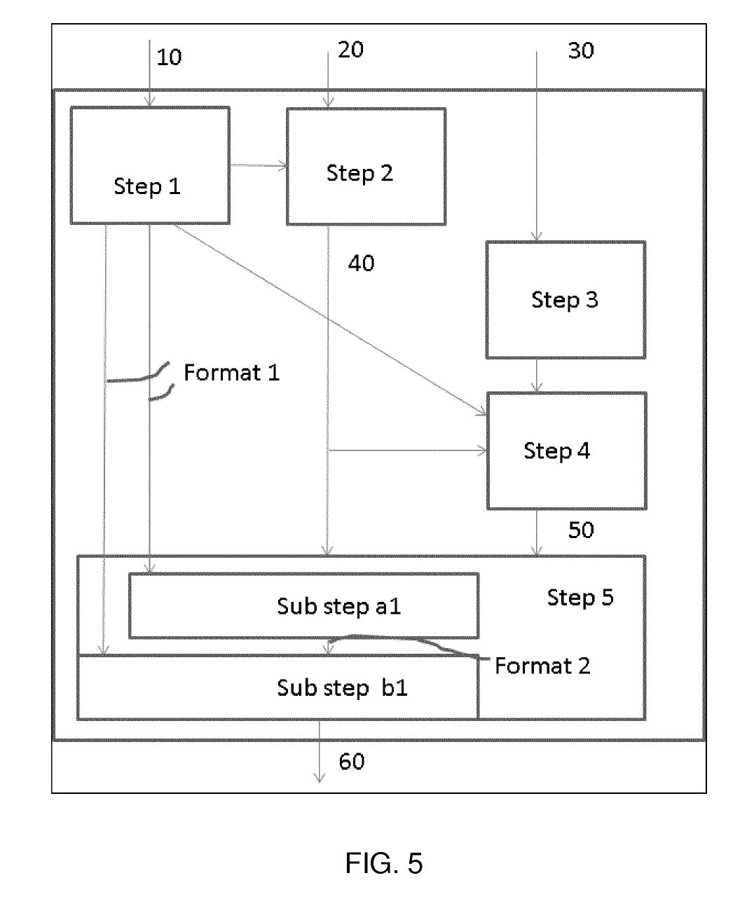

As indicated in the invention (all or substantially all of) said texts are preferably represented in a graph format, more in particular said texts are represented in an N-gram language model, preferably a bi-gram language model. Note that optionally in view of certain characteristics of texts, one may decide to use a particular graph type, even on a text by text basis, for instance text with lists of words can be better represented by a so-called list-gram. Based on the graph format, one may include intelligence to the methods by taking into account in the one or more steps of the methods bi-grams having an informative value above a threshold (for instance expressed as an occurrence in at least a predetermined amount of said second texts or otherwise), optionally said predetermined amount or said threshold is determined by said operational context Also as indicated the invention uses various formats, being different in informative content but also computational intensity. Likewise this leads to other types of graphs. Indeed as said second format used in the invention comprising indicators (Semantic Theme Aspects) of set of words (bi-grams) shared by two or more of said second texts (as determined in sub step a1), the invention further provides an auxiliary graph where each node represents a set of (two) consecutive words, occurring at least in two of said texts, each node having as property those set of texts wherein said set of words occurs; and the edges represent the relationship whether the set of texts indicated in the property of a first node being a subset of the property of said second node, preferably such edge only be present if the relationship cannot be represented by edges between other nodes. The purpose is to give a quick path to the Semantic Theme Aspects and therefore the auxiliary graph contributes to the aim of the invention. Recall that the auxiliary graph is constructed as nodes, being the actual bigrams of the network (of data) with as property for those nodes the documents they occur in and as edges the relationship that evaluates the property ‘is part of’. This way, Semantic Theme Aspects are the roots of this graph (i.e. all the bigrams one can reach by descending from the root to all of its leafs and their leafs). So, when we have a document, we simply take all of the bigrams of the documents, look them up in the sub graph, traverse the sub graph until we reach the roots (each time) and see what leafs are under those roots. Finding the Semantic Theme Aspects of a bigram is even more trivial (i.e. sub process of the above approach). Some care must be taken when calculating the “is part of relation”, since a lot of relations incorporate other relations. An example will show this. Imagine you have the corpus in mind represented by FIG. 1. You would intuitively think this would lead to the following auxiliary graph of FIG. 2. Mathematically, the computation of the “is part of relation” in the above example will lead to FIG. 3. Although this graph could be considered to be correct, we don't need the “red” relations to compute the Semantic Theme Aspects. In practice, those “red” relations will increase the number of needed computations dramatically (and therefore be very bad for overall performance). Nevertheless, the problem is not trivial, since for instance, we do need the relation between bigram E and F. This can be solved by using the recursive process of FIG. 4.

Note that, as explained above, another embodiment of the auxiliary graph can be used too and that, in an alternative implementation, one can (partially) use skeletons of STAs instead of the real STAs.

In most of the operational contexts, the plurality of second texts is not invariable over time. Indeed, texts may need to be added to the plurality of second texts or may need to be deleted from the plurality of second texts. The latter being the case in some operational contexts (e.g. marketing) where text may become less relevant over time and need to be deleted from the plurality of second texts (another embodiment might deal differently with this time-aspect).

Two extreme methods to accomplish these adding and/or deleting texts to/from the plurality of second texts are being described here.

The first method involves some extra calculation (extra to the first format) upfront to make things still computable when the second format needs to be recalculated. Basically, here is how it works: (1) during loading of new texts or deletion of texts from the plurality of second texts some extra computations are being done (2) newly added/deleted texts are being ignored for text analysis operations (3) whenever a threshold of texts is being added/deleted the second format is being recalculated for the complete set of the plurality of second texts (4) the newly added/deleted texts are from now on taken into account for next text analysis operations.

It is clear that the first method will lead to a period of time during which the database is not accurate (to a certain extend) anymore. For business cases that can't afford to operate text analysis on a database being not accurate, a second method has been discovered. The second method is based on the fact that the formulas used to calculate the first format (and indirectly also the second format) heavily resemble those of probability calculations and therefore allow to add (or subtract for deletion) the results of the calculations on subgroups of the plurality of second texts, provided those subgroups are large enough and are independent of each other. The latter defines the rough business context that defines the usage of this second method: texts cannot be added (or deleted) individually but should be added (or deleted) in large groups of texts.

Said in more general terms, the invention describes (computer implemented) methods for adding a new text and/or removing a text from a plurality of second texts, said methods being capable either (a) to exploit features of the new text in relation to the second texts, for instance whether it is a near copy or not and/or (b) a characteristic of itself such as its size. As explained above as the purpose is not to start all over again when a text must be added or deleted, and hence an incremental approach is recommended, preferably without disturbing the access to the corpus, wherein it is identified how said text is related to the other of said second texts in said format by exploring the formulas.

In the above the use of one or more reference documents, also called proxies was described. One may provide in an embodiment of the invention the hand picking the proxy. The proxy can be seen as a filter or as a decision taken at a crossing. Therefore, even with many proxies, it remains hard to “guess” what decision a user would take. Therefore, for some business cases, an extra step in the process is provided whereby the user is interactively requested to choose between the most likely proxies. If the similarity between the proxies is below a threshold, the question is not put to the user. Alternatively stated a plurality of reference texts are determined for use as starting basis for further steps and optionally the user elects one of those, and preferably the user only is being able to do this if justified (which might be business or context specific again and hence a variable that can be changed as a function of the set of texts to work or operate on).

The concept of Q-trail is added to guide a user during his/her data mining operations. Here is how it works: Whenever a user has selected a document, he/she is actually on a crossing; he/she does not know how to proceed from here because a lot of documents are in the “neighbourhood” of the selected document. In embodiments of the present invention, neighborhood is expressed via a distance metric being representative for the resemblances of the texts. In particular embodiments, neighborhood is expressed in function of a distance metric being representative for the (shortest) path over semantic bridges between documents of the corpus.

Based upon the information on those documents in the “neighbourhood” of the selected document (via associations), the user selects a next document. Q-trail guesses the goal of the user (its final target) based upon the start document and its choices afterwards. Once the goal gets clear, Q-trail will make a suggestion for the next move of the user. If the user defers from the suggestion of the Q-trail, Q-trail is recalculated to make a new suggestion. Selected documents are being kept to do further analysis. Hence in an embodiment of the invention the graphical user interface suited for use with any of the methods described, said graphical user interface comprises means for providing suggestions to the user in a data mining operation.

The concept of “Context Revealing and Picking (CRaP)”, with related “angling” navigation-style, offers to the user of a search request a rich context based response. To get to this response, in an embodiment of the invention one operates as follows: (a) the starting point is always a first text; (b) starting from this first text one looks for a set of related texts via first format relationships, optionally at distance 1; the found related texts are being filtered for instance but not limited to a main core extraction as described above and are being grouped based upon second format relationships; based on this grouping the “most prominent context” is being determined with within a set of retained texts (after said above filtering); (c) starting from each of the retained texts one looks for a set of related texts, this time, via second format relationships at distance 1 and preferably with taking into account protection against “topic drift” (the latter is achieved by requiring that the second format relationships always relate to the first text referred to in (a)); the related texts are again grouped based on the second format relationships; based on this grouping we get the above said “other” contexts with within related texts. Those “other” contexts are named in order to (c1) on the one hand disclose their content and (c2) on the other hand summarize their content and (c3) on the other hand indicate the-direction-away-from-the-first-text and (c4) on the other hand clarify the overlap between the different “other” contexts.

In a specific implementation of the CRaP-method one compares in step (c) the texts of the different “other” contexts with each other in order to have the returned texts in the different “other” contexts being mutually distinctive.

In a specific implementation of the CRaP-method one uses (optionally filtered) bigrams as first format relationships, STAs as second format relationships and words of the first text having to occur in the STAs as topic drift protection.

In a variant of the CRaP-method, one does not look only at distance 1.

In a specific implementation of the CRaP-method one uses associations to name the “other” contexts.

In a specific implementation of the CRaP-method one uses bigrams of the STAs to name the “other” contexts.

The “angling” navigation style makes the CRaP-method applicable to any returned document and hereby offers to the user of it a very context-driven navigation-style (throughout the network of second texts when looking for what relates to the text of the search request).

As mentioned before texts are represented based upon bigrams. This works most of the time fine. However, whenever the database contains lists in an arbitrary sequence our principal bridging patterns might not work anymore. Therefor we introduced the concept of a list-gram whereby rules are defined to find begin and end of the list-gram and whereby the “equals” method of the list-gram is less restrictive than the one of a bigram.

While the invention can work with documents of variable length, this leads to computations of unpredictable duration. Therefore we introduced a (random based, configurable) chunk as atomic part of the document. As a positive side effect, important relations at long distance within one document become as important as the same relations in different documents. Therefore a (computer implemented) method for creating said plurality of second texts in a format suitable for use in any of the methods is provided comprising the steps of: determining whether the size of the text to be added is less than a predetermined value; and if so the new text is processed in order to add it into said plurality of second text in said format; if not the new text is split into sub texts satisfying said size constraint; and each of said sub texts are processed in order to add it into said plurality of second text in said format.

Similarly to increase performance, a PageRank algorithm can be introduced whereby we replace the Hyperlinks by Semantic Theme Aspects as bridging pattern. The advantage of using the PageRank instead of the proxy-similarity is that we can do the PageRank calculation upfront and gain performance for real-time queries.

In reality lots of business cases will have databases that contain near copies of documents (e.g. a Share point database that contains all versions of a document). To keep things computable, we first calculate the similarity of a new document-to-be-added compared with all documents already present in the database. We use a hash value per document to make this computation fast. If the similarity is high (tolerance of 5%), then the document is considered to be a near copy and is stored as such. It is not added to the core network of the engine. Therefore the invention provides a (computer implemented) method for adding a new text into a plurality of second texts in a format suitable for use in any of the methods discussed, comprising the steps of: determining whether the new text is a near copy of one of said second texts in accordance with a similarity criterion, preferably by use of a hash function; if said new text is (to be considered) a near copy, the new text is marked as such and not added to the plurality of second texts in said format; otherwise the new text is processed in order to add it into said plurality of second text in said format.

Note that time—such as time of entry of a document or even just the time at which a document or text was generated—might be a valuable attribute of such document. The above methods are adapted to use such time attribute. Indeed—depending on the business case at hand—the time attribute might be used to elect which part of the data base to access and/or as a steering factor in the maintenance of the data base.

As the above methods typically are used for very large databases of texts, distributed storage of the data and/or processing (including parallel processing) or executing of the methods over a variety of computation engines is recommended.

Further obviously part or the entire database may provide secret data, for which security provisions, like controlled access, encryption . . . might apply. The above discussed methods are adapted to work in such restricted environments for instance by enabling generating proper outputs without entire disclosing the secret parts of such databases.

1.-30. (canceled)

31. A computer implemented method for identifying, in a plurality of second texts, one or more texts semantically resembling a first text, the method comprising the steps of:
(step 1) loading said plurality of second texts, each of said second texts being provided in a first computer processing format, representing said second texts in an N-gram model, wherein said first computer processing format provides a plurality of first semantic relationships between texts of said plurality of second texts;
(step 2) determining of an operational context, said determining of an operational context comprising getting characteristics of the first text and characteristics of the plurality of second texts;
(step 3) getting the first text;
(step 4) after step 2, determining of at least one reference text in said plurality of second texts, said at least one reference text comprising a measure of semantic resemblance with said first text, said determining of at least one reference text being based on mining or a user query; and
(step 5) after step 2, determining, within said plurality of second texts, of one or more texts semantically resembling said first text to thereby obtain one or more identified texts, said determining within said plurality of second texts of one or more texts semantically resembling said first text starting with said at least one reference text, wherein step 4 (said determining of said at least one reference text) and/or step 5 (determining within said plurality of second texts of one or more texts semantically resembling said first text) is taking the operational context into account in order to achieve a predefined performance goal, wherein step 4 and/or 5 are using one of a plurality of different methods, the used method being automatically selected by use of said operational context, wherein said predefined performance goal includes execution time.

32. The method of claim 31, wherein step 5 comprises:
(sub step a1) first processing at least a part of said plurality of second texts in order to arrange them in a second computer processing format, wherein said second computer processing format provides second relationships between said second texts, said second computer processing format expresses the semantic resemblances between said second texts better than said first computer processing format, and (sub step b1) thereafter said determining of one or more texts is being based on second computer processing format.

33. The method of claim 32, wherein step 5 comprises:
(sub step a2) selecting which second texts will be used in said determining step of step 5;
(sub step b2) searching through said plurality of second texts; and
(sub step c2) selecting which second texts will be retained after sub step b2; and
whether one or more of said sub steps a2, b2, c2 uses either said first or second computer processing format is (automatically) selected in accordance with said operational context.

34. The method of claim 31, wherein at least one of said reference texts is the text in said plurality of second texts having most words in common with the first text provided in step 3.

35. The method of claim 31, wherein said operational context is defined in terms of the size of the first text provided in step 3 and the size of said second texts.

36. The method of claim 31, wherein in step 4 a plurality of reference texts are determined for use as starting basis of step 5, optionally a user elects one of those, and preferably the user only is being able to do this if the semantic resemblance of those is above a threshold.

37. The method of claim 31, wherein step 5 is an iterative process wherein an intermediate set of texts being determined is based on the semantic resemblance of said intermediate set of texts with said at least one reference text; followed by ranking said intermediate set of texts and retaining only a portion thereof; and repeating said step based on said retained texts, preferably the characteristics of said ranking and/or retaining process being determined by said operational context.

38. The method of claim 32, wherein determining of the part to be processed in sub step al of said plurality of second texts is based on said operational context.

39. The method of claim 32, wherein based on said operational contexts the choice is made between processing the entire plurality of second texts or only the neighborhood of one or more of said reference texts, wherein the neighborhood is expressed via a distance metric being representative for the semantic resemblances of the texts.

40. The method of claim 31, wherein said step 5 only takes into account bi-grams having an informative value above a predetermined threshold, optionally said threshold being determined by said operational context.

41. The method of claim 31, wherein said second computer processing format comprises indicators of set of words, representing a semantic theme aspect, shared by two or more of said second texts, as determined in sub step al.

42. The method of claim 31, whereby an auxiliary graph comprising nodes and edges is used, where each node represents a set of consecutive words, occurring as consecutive words in at least in two of said second texts, each node having as property those set of texts wherein said set of words occurs; and where the edges represent the relationship whether the set of texts indicated in the property of a first node is a subset of the property of said second node.

43. The method of claim 42, whereby an auxiliary graph comprising nodes and edges is used where each node represents a set of bigrams, whereby each element of the set occurs in the related set of second texts of that node; and where the edges represent the relationship whether the set of texts of a first node being a subset of the set of texts of said second node.

44. A computer program product for executing methods as in claim 31 on a processing engine.

45. A non-transitory machine readable storage medium storing the computer program products of claim 44.

46. A computer implemented method for adding a new text into a plurality of second texts in a computer processing format suitable for use in claim 31, comprising the steps of:
determining whether the new text is a near copy of one of said second texts, being a copy having in accordance with a similarity criterion a high similarity, preferably by use of a hash function; if said new text is a near copy or to be considered as such, the new text is marked as such and is not added to the plurality of second texts in said computer processing format; otherwise the new text is processed in order to add it into said plurality of second text in said computer processing format.

47. A computer implemented method for creating said plurality of second texts in a computer processing format suitable for use in the method of claim 31, comprising the steps of:
determining whether the size of the text to be added is less than a predetermined value; and if so the new text is processed in order to add it into said plurality of second text in said computer processing format; if not the new text is split into sub texts satisfying said size constraint; and each of said sub texts are processed in order to add it into said plurality of second texts in said computer processing format.

48. A computer implemented method for removing a text from a plurality of second texts made available in a computer processing format suitable for use in the method of claim 32, comprising the steps of:
identifying how said text is related to the other of said second texts in said computer processing format, in particular whether said first or second computer processing format is used; and adapting the corresponding computer processing format.

49. A computer implemented method for identifying for a first text in a plurality of second texts a plurality of texts semantically resembling said first text; the method comprising:
(step 1) loading said plurality of second texts, each of said second texts being provided in a first computer processing format, representing said second texts in an N-gram model, wherein said first computer processing format provides a plurality of first semantic relationships between texts of said plurality of second texts;
(step 2) getting a first text;
(step 3) determining a plurality of texts semantically resembling said first text in the plurality of second texts, wherein:
at least part of said plurality of second texts is being processed to organize them in a second computer processing format, said second computer processing format defines second relationships between said texts and the first text, said second computer processing format expresses the semantic resemblance between said texts better than said first computer processing format, wherein in said second computer processing format, the Semantic Theme Aspect, represented by indicators of a set of words, is exploited and said determining of a plurality of texts goes as follows:
determining a plurality of contexts for the first text based on grouping texts based on first and/or second relationships and followed by a selection of those contexts and for each of those contexts individually determining a plurality of texts to thereby obtain one or more identified texts based on first and/or second relationships wherein first relationships create a first context; and possibly for each of those texts within this first context second relationships create several second contexts.

50. The method of claim 49, wherein said texts are represented in an N-gram language model, preferably a bi-gram language model, even more in particular texts in said first computer processing format are in a bi-gram language model.
